(19) United States
(12) Patent Application Publication
(10) Pub. No.: US 2007/0081274 A1
(43) Pub. Date: Apr. 12, 2007

(54) Pinch roller driving mechanism for a magnetic recording/reproducing apparatus

(75) Inventors: Jun-young Kim, Suwon-si (KR); Jun-young Lee, Yongin-si (KR); Jung-hyeon Kim, Yongin-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/358,415

(22) Filed: Feb. 22, 2006

(30) Foreign Application Priority Data
Oct. 7, 2005 (KR) 10-2005-0094589

(51) Int. Cl. G11B 5/54

(52) U.S. Cl. 360/255.1

(57) ABSTRACT

A pinch roller driving mechanism for a magnetic recording/reproducing apparatus, includes a main deck mounting a shaft of a capstan motor, a sub-deck that is loaded and unloaded with respect to the main deck, a pivot lever that is pivotably mounted to the main deck and supports a pinch roller that presses a magnetic tape into contact with the capstan shaft as the sub-deck is loaded, and an association unit that pivots the pivot lever so that the pinch roller contacts the shaft when the sub-deck is loaded, and returns the pivot lever to its initial position when the sub-deck is unloaded.

### CROSS-REFERENCE TO RELATED APPLICATIONS

This application claims the benefit under 35 U.S.C. § 119(a) of Korean Patent Application No. 2005-94589, filed on Oct. 7, 2005, in the Korean Intellectual Property Office, the entire disclosure of which is hereby incorporated by reference.

### BACKGROUND OF THE INVENTION

1. Field of the Invention

The present invention relates to a magnetic recording/reproducing apparatus. More particularly, the present invention relates to a pinch roller driving mechanism for a magnetic recording/reproducing apparatus for pressing a magnetic tape against a shaft of a capstan motor.

2. Description of the Related Art

Generally, a magnetic recording/reproducing apparatus records information on a recording medium and reproduces the recorded information. Examples of magnetic recording/reproducing apparatuses include video cassette recorders (VCR) and camcorders.

A typical magnetic recording/reproducing apparatus comprises a main deck where a rotatable head drum is mounted, and a sub-deck slidably mounted to the main deck to move in the direction of tape loading and unloading. A pair of pole base units move and support the tape so that the tape is wound on the head drum when the sub-deck is loaded. A tape guide device guides the loaded tape while the tape is running.

The tape guide device comprises a shaft of a capstan motor fixed to the main deck, and a pinch roller unit bringing the tape into contact with the shaft of the capstan motor in association with a sliding member. The sliding member moves on the main deck in a transverse direction of the movement of the sub-deck.

The pinch roller unit comprises a pivot lever pivotably mounted to the main deck, a pinch roller rotatably mounted to an end of the pivot lever, and a recovery spring returning the pivot lever to its initial position.

The pivot lever is pivoted in association with the loading of the sub-deck, thereby bringing the pinch roller into contact with the capstan roller shaft. After the sub-deck is loaded, the sliding member is moved in a certain direction, thereby biasing a pressing lever formed on the pivot lever. Therefore, the pressing lever, being compressed, brings the pinch roller into tight contact with the capstan motor shaft. When the sub-deck is unloaded, the pivot lever is returned to its initial position by the force of the recovery spring.

In the above-described conventional pinch roller unit, the recovery spring provided to return the pivot lever to the initial position increases the number of component parts and increases the complexity of the pinch roller unit.

In addition, if the recovery force of the recovery spring deteriorates, the pivot lever may not return to the desired initial position.

Furthermore, since the force of the recovery spring is in an opposite direction to a force pressing the pinch roller to the capstan motor shaft, the contact between the pinch roller and the capstan motor shaft may be unstable.

Accordingly, there is a need for an improved pinch roller unit that operates more effectively and has a simpler structure.

### SUMMARY OF THE INVENTION

An aspect of the present invention is to address at least the above problems and/or disadvantages and to provide at least the advantages described below. Accordingly, an aspect of the present invention is to provide a pinch roller driving mechanism for a magnetic recording/reproducing apparatus, which is capable of improving the operation of the pinch roller unit and simplifying the structure of the unit.

In accordance with an aspect of the present invention, a pinch roller driving mechanism for a magnetic recording/reproducing apparatus comprises a main deck, a sub-deck, a pivot lever, and an association unit. The main deck supports a shaft of a capstan motor. The sub-deck is loaded and unloaded with respect to the main deck. The pivot lever is pivotably mounted to the main deck and supports a pinch roller that presses the magnetic tape into contact with the shaft as the sub-deck is loaded. The association unit pivots the pivot lever so that the pinch roller contacts the shaft when the sub-deck is loaded, and returns the pivot lever to its initial position when the sub-deck is unloaded.

The association unit may comprise a projection part that projects from the pivot lever, and a leading end contact part that extends from a leading end of the sub-deck to contact the projection part and push out the projection part when the sub-deck is loaded. The projection part is magnetized to maintain contact with the leading end contact part so that when the sub-deck is unloaded, the projection part is attracted towards the projection part and restored to its initial position.

The projection part may comprise a magnetized, upwardly projecting, pin.

The association unit may comprise a projection part that projects from the pivot lever, a leading end that extends from a leading end of the sub-deck to contact the projection part and push out the projection part when the sub-deck is loaded, and an electromagnetic part mounted on the sub-deck to face the pivot lever and generate a magnetic force upon the application of power, thereby attracting the pivot lever and returning the pivot lever to an initial position by magnetic force when the sub-deck is unloaded.

The electromagnetic part may comprise a flexible printed circuit board (FPCB) mounted on the sub-deck and having a pattern for power application, and an electromagnet connected with the FPCB by, for example, welding.

The association unit may comprise a projection part that projects from the pivot lever, and a guide slit formed at the leading end of the sub-deck to receive the projection part and guide the projection part when the sub-deck is loaded so that the pivot lever is operated.

The guide slit may be formed at a leading, extended end of the sub-deck to correspond to the pivot lever.

The association unit may comprise a projection part that projects from the pivot lever, a leading end contact part that extends from a leading end of the sub-deck to contact the projection part and push the projection part when the sub-deck is loaded, a rubber band supported by the pivot lever and the main deck, and a sliding member mounted to the main deck to slide in a direction transverse to a moving direction of the sub-deck. The movement of the sliding member adjusts the tension applied to the rubber band. In particular, the tension of the rubber band is increased as the sliding member moves in one direction, thereby returning the pivot lever to its initial position.

The main deck may comprise at least two fixing hooks for catching and supporting the rubber band, and the pivot lever may comprise a holding hook for holding the rubber band between a shaft of the pivot lever and the pinch roller.

The fixing hooks and the holding hook may be arranged to form a triangle.

The sliding member may comprise a pressing pin that projects upward to contact and bias the rubber band.

The pinch roller driving mechanism may further comprise a torsion spring coaxially mounted with the pinch roller. One end of the torsion spring is compressed by interference with the sliding member when it moves in a direction that reduces the tension of the rubber band, thereby biasing the pivot lever toward the shaft.

The pinch roller driving mechanism may further comprise a torsion spring coaxially mounted with the pinch roller, and a sliding member mounted to the main deck to move in a sliding manner in a direction transverse to the moving direction of the sub-deck. The torsion spring is compressed by interference with sliding member when it moves in one direction, thereby biasing the pivot lever toward the shaft.

In accordance with another aspect of the present invention, a pinch roller driving mechanism for a magnetic recording/reproducing apparatus comprises a main deck supporting a capstan motor with a shaft, a sub-deck slidably disposed on the main deck, the sub-deck moving in a loading and unloading direction to load and unload the sub-deck with respect to the main deck, a pivot lever pivotably disposed on the main deck, a pinch roller disposed on the pivot lever, means for engaging the pivot lever so that the pinch roller presses a tape into contact with the shaft of the capstan motor as the sub-deck is loaded, and magnetic means for returning the pivot lever to its initial position when the sub-deck is unloaded.

The magnetic means may include a magnetic projection part that projects from the pivot lever.

The magnetic means may include an electromagnetic part disposed on the sub-deck, the magnetic means generating a magnetic force upon application of power to attract the pivot lever when the sub-deck is unloaded.

A sliding member may be disposed on the main deck, with the sliding member moving transversely to the transverse direction to the loading and unloading direction of the sub-deck, and a torsion spring may be coaxially mounted with the pinch roller. The sliding member applys a force to one end of the torsion spring to bias the pivot lever toward the shaft.

In accordance with another aspect of the present invention, a pinch roller driving mechanism for a magnetic recording/reproducing apparatus comprises a main deck supporting a capstan motor with a shaft, a sub-deck slidably disposed on the main deck, the sub-deck moving in a loading and unloading direction to load and unload the sub-deck with respect to the main deck, a pivot lever pivotably disposed on the main deck, a pinch roller disposed on the pivot lever, means for engaging the pivot lever so that the pinch roller presses a tape into contact with the shaft of the capstan motor as the sub-deck is loaded, a rubber band supported by the pivot lever and the main deck, and a sliding member mounted to the main deck to move transversely to the loading and unloading direction of the sub-deck. The movement of the sliding member adjusts the tension applied to the rubber band, and the sliding member moves to increase the tension of the rubber band to return the pivot lever to its initial position.

The main deck may comprise at least two fixing hooks for catching and supporting the rubber band, and the pivot lever may comprise a holding hook for holding the rubber band between a shaft of the pivot lever and the pinch roller.

The fixing hooks and the holding hook may be arranged to form a triangle.

### BRIEF DESCRIPTION OF THE DRAWING FIGURES

The above and other objects, features, and advantages of certain exemplary embodiments of the present invention will be more apparent from the following description taken in conjunction with the accompanying drawings, in which:

FIG. 1 is a schematic, plan view of a pinch roller driving mechanism for a magnetic recording/reproducing apparatus according to an exemplary embodiment of the present invention;

FIG. 2 is a schematic, plan view of a sub-deck in a loaded position in the magnetic recording/reproducing apparatus of FIG. 1;

FIGS. 3A and 3B are a plan view and a sectional view, respectively, of a pinch roller driving mechanism for a magnetic recording/reproducing apparatus according to another exemplary embodiment of the present invention;

FIGS. 4A and 4B are plan views of the pinch roller driving mechanism of FIG. 3A in a play mode and a stop mode, respectively;

FIG. 5A is a schematic, plan view of a pinch roller driving mechanism for a magnetic recording/reproducing apparatus according to yet another exemplary embodiment of the present invention;

FIGS. 5B and 5C are plan views of the pinch roller driving mechanism of FIG. 5A in a stop mode and an unloading mode, respectively;

FIGS. 6A and 6B are a sectional view and a plan view, respectively, showing a pinch roller driving mechanism of a magnetic recording/reproducing apparatus according to still another exemplary embodiment of the present invention; and

FIGS. 6C and 6D are plan views of the pinch roller driving mechanism of FIGS. 6A and 6B in a stop mode and an unloading mode, respectively.

Throughout the drawings, the same reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

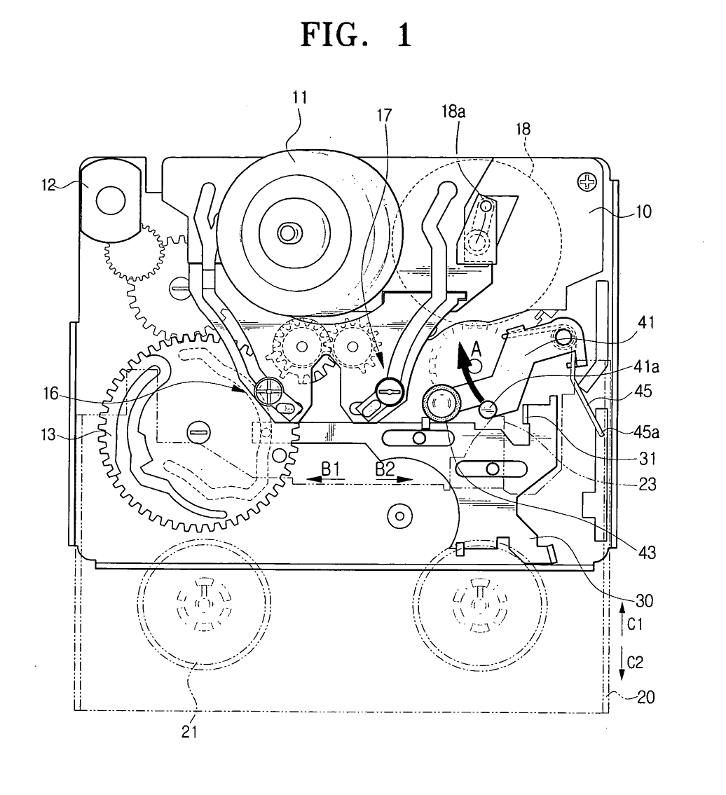

Referring to FIG. 1, a pinch roller driving mechanism for a magnetic recording/reproducing apparatus according to an exemplary embodiment of the present invention comprises a main deck 10 on which a head drum 11 is mounted, a sub-deck 20 that moves with respect to the main deck 10, a sliding member 30 that slides on the main deck 10, a pivot lever 41 that supports a pinch roller 43, and an association unit.

A shaft 18a of a capstan motor 18 is mounted on the main deck 10, preferably vertically. A pair of pole base units 16 and 17 are mounted to a rail on the main deck 10 to press a magnetic tape drawn from a tape cassette into contact with the head drum 11. The pole base units 16 and 17 are driven in association with a cam gear 13, which is rotated by a driving force of a driving motor 12.

The sub-deck 20 includes a reel disc 21 that joins with a tape reel of the tape cassette. When the sub-deck 20 is loaded with a tape cassette seated on the sub-deck 20, the magnetic tape is drawn out by tape guide members such as the pinch roller 43 and the pole base units 16 and 17, so that the tape contacts the head drum 11. The loading and unloading operation of the sub-deck 20 is performed in association with the cam gear 13. The operation of loading and unloading the sub-deck 20 is generally known to those skilled in the art, and, therefore, a detailed description of the operation is omitted for conciseness.

The sliding member 30 moves in directions B1 and B2, which are transverse to the moving direction of the sub-deck 20. Preferably, the moving directions B1, B2 of the sliding member 30 are substantially perpendicular to the moving direction of the sub-deck 20. The sliding member 30 moves in association with a cam slit formed at the cam gear 13 when the cam gear 13 is rotated.

When being loaded, the pinch roller 43 draws out and brings the tape into contact with the shaft 18a. The pinch roller 43 is rotatably mounted to one end of the pivot lever 41. The pivot lever 41 is pivotably mounted to the main deck 10.

The association unit pivots the pivot lever 41 toward the shaft 18a and returns the pivot lever 41 in the opposite direction according to the loading and unloading of the sub-deck 20. The association unit comprises a projection part 41a that projects from the pivot lever 41, and a leading end contact part 23 that extends from a leading end of the sub-deck 20 to contact the projection part 41a.

The projection part 41a may be formed integrally with the pivot lever 41 or may be formed by connecting a dedicated pin to the pivot lever 41. The leading end contact part 23 is preferably integrally formed with the sub-deck 20, and pushes out the projection part 41a when the sub-deck 20 is loaded, so that the pivot lever 41 can be pivoted in a direction A.

In addition, the projection part 41a is magnetized so as to maintain contact with the leading end contact part 23 by a magnetic force. Since it is magnetized, the projection part 41a is drawn into contact with the leading end contact part 23 by the magnetic force of the projection part 41a when the sub-deck is unloaded 20. Accordingly, the pivot lever 41 can be returned automatically to its initial position. As a result, a dedicated recovery spring for restoring the position of the pivot lever 41 is not required, thereby reducing the number of components. The projection part 41a may be formed by swaging the pivot lever 41.

Furthermore, a pressing member, for example, a torsion spring 45, is mounted coaxially with the pivot lever 41. The torsion spring 45 extends so that the first end 45a of the torsion spring selectively interferes with the sliding member 30. The torsion spring 45 supplies a biasing force for further pushing the pivot lever 41 in the direction A so that the pinch roller 43 can be more tightly contacted with the shaft 18a. After the torsion spring 45 is primarily pivoted together with the pivot lever 41 in the direction A, the first end 45a of the torsion spring 45 is further pivoted by the contact part 31 of the sliding member 30 as the sliding member 30 is moved in the direction B1.

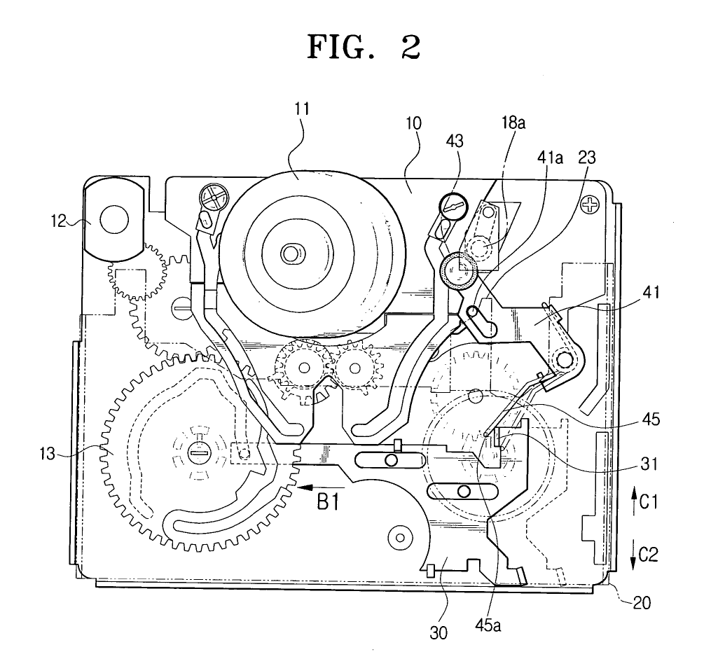

The operation of the pinch roller driving mechanism for the magnetic recording/reproducing apparatus according to an exemplary embodiment of the present invention will now be described. First, the sub-deck 20 is in the state shown in FIG. 1. That is, the sub-deck 20 is unloaded from the main deck 10. The sub-deck 20 is loaded in the direction C1. Therefore, the leading end contact part 23 of the sub-deck 20 pushes the projection part 41a of the pivot lever 41, thereby pivoting the pivot lever 41 in the direction A. Accordingly, the torsion spring 45 is also pivoted in the direction A. As shown in FIG. 2, the pinch roller 43 is brought into contact with the shaft 18a. The first end 45a of the torsion spring 45 is disposed on the left of the contact part 31 of the sliding member 30. The sliding member 30 is then moved in the direction B1 by operation of the cam slit in the cam gear 13. Therefore, the contact part 31 biases the first end 45a of the torsion spring 45 in the direction B1. The torsion spring 45 is compressed and therefore, the pinch roller 43 is pressed into tighter contact with the shaft 18a. When the loading is thus completed, recording and reproducing of information with respect to the magnetic tape can be performed.

When the sub-deck 20 is unloaded in the direction C2, the torsion spring 45 is first released from the sliding member 30. When the unloaded sub-deck 20 is moved, the projection part 41a is accordingly moved, since it is attracted towards the leading end contact part 23 by the magnetic force. In association with the sub-deck 20, the pivot lever 41 is returned to its initial position.

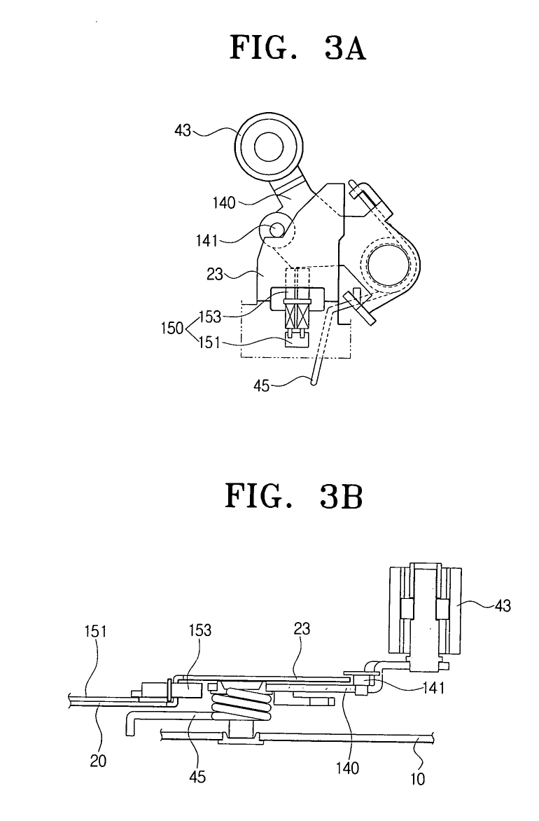

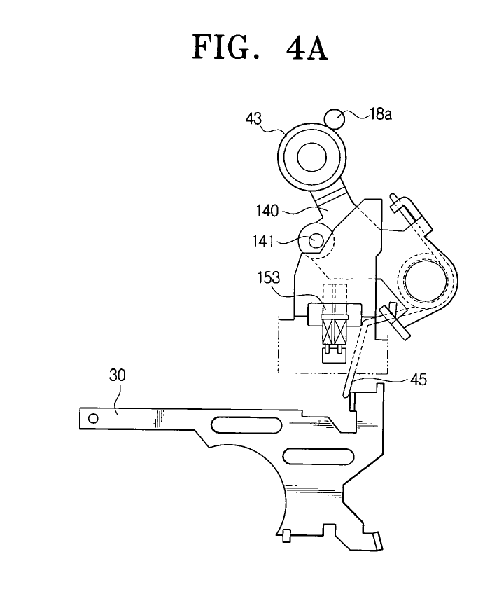

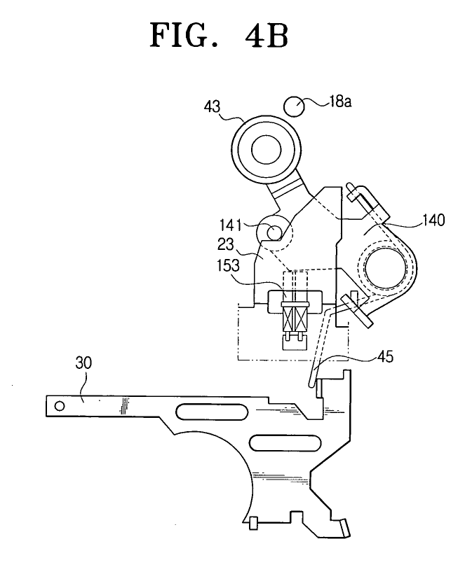

FIGS. 3 and 4 show another exemplary embodiment of the present invention. Referring to FIGS. 3A and 3B, the association unit comprises a projection part 141 that projects from a pivot lever 140, the leading end contact part 23 that extends from the leading end of the sub-deck 20 to contact the projection part 141 and push the projection part 141 during loading of the sub-deck 20, and an electromagnetic part 150 mounted on the sub-deck 20 to face the pivot lever 141 and generate a magnetic force upon application of power, thereby contacting the pivot lever 141. The projection part 141 has the same structure as the projection part 41a of the previous exemplary embodiment, but does not need to be magnetized.

The electromagnetic part 150 comprises a flexible printed circuit board (FPCB) 151 supported by the sub-deck 20 to apply power, and an electromagnet 153 electrically connected with the FPCB 151 by any suitable means, such as welding. The FPCB 151 is supported by the sub-deck 20. The electromagnet 153 generates a magnetic force upon application of power by the FPCB 151, thereby attracting the pivot lever 140 towards the electromagnet.

As shown in FIG. 4A, the electromagnet 153 is off when the sub-deck 20 is in a play mode. Therefore, the electromagnet 153 is not generating a magnetic force, and the pivot lever 140 receives all of the biasing force of the torsion spring 45 by the sliding member 30 and is kept in tight contact with the shaft 18a. In other words, there is no force operating in the opposite direction of the force biasing the pinch roller 43 toward the shaft 18a. Accordingly, the stability of the tape while it is running, and the overall reliability of the product, are improved.

When the sub-deck 20 is in a stop mode (that is, the tape is stationary and does not move), as shown in FIG. 4B, the sliding member 30 is moved a little to the right to release the torsional force of the torsion spring 45 and thereby release the biasing force of the pinch roller 43 on the shaft 18a. In this state, power is applied to the electromagnet 153 to generate a magnetic force. As shown in the drawing, the pivot lever 140 is brought into contact with the electromagnet 153 by the magnetic force. When unloading the sub-deck 20, power is applied to the electromagnet 153, and the pivot lever 140 returns to its initial position while attached to the electromagnet 153 by the magnetic force of the electromagnet 153.

When loading the sub-deck 20, the pivot lever 140 can be pivoted because the projection part 141 is pushed by the leading end contact part 23 in association with the sub-deck 20. As a result, the pivot lever 140 can be accurately operated, thereby improving the reliability of the product.

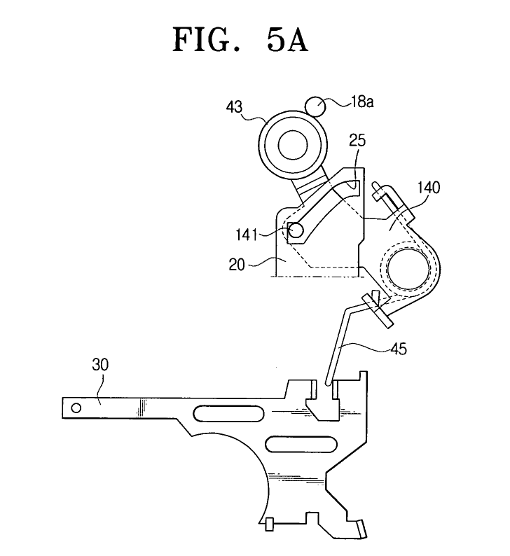

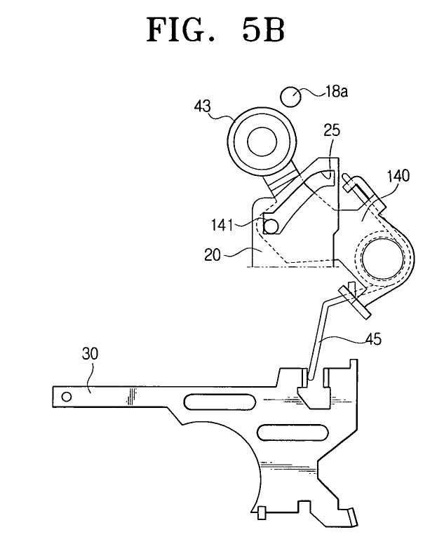

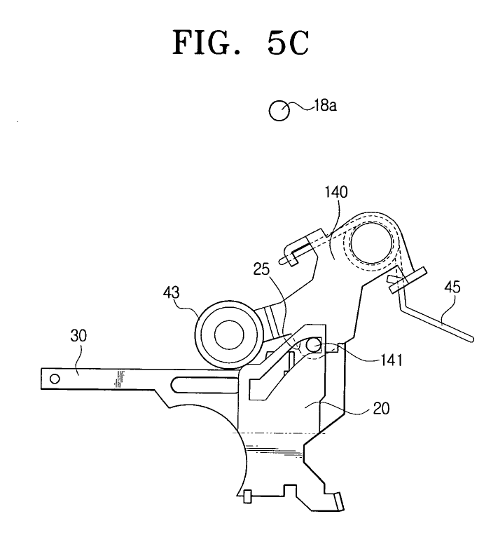

Referring to FIG. 5A, an association unit according to yet another exemplary embodiment of the present invention comprises a projection part 141 that projects from the pivot lever 140, and a guide slit 25 formed at the sub-deck 20. The projection part 141 is inserted into the guide slit 25 to guide the projection part 141 while the sub-deck 20 is moved, accordingly operating the pivot lever 140. The projection part 141 may be formed integrally with the pivot lever 140 or formed by connecting a dedicated pin to the pivot lever 140.

The guide slit 25 is formed at a position where the leading end of the sub-deck 20 is extended. The projection part 141 is inserted in the guide slit 25. As shown in FIG. 5A, according to the above structure, when the sub-deck 20 is in the play mode, the projection part 141 moves in association with the guide slit 25, thereby moving the pivot lever 140 toward the shaft 18a. Then, the torsion spring 45 is biased by the sliding member 30 and accordingly, the pinch roller 43 tightly contacts the shaft 18a by the biasing force.

As shown in FIG. 5B, when the sub-deck 20 is in the stop mode, in other word, when the sub-deck 20 is not operating, the biasing force of the torsion spring 45 is released so that the pinch roller 43 separates from the shaft 18a. The guide slit 25 is sufficiently wide at one end to allow small movements of the pivot lever 140. Referring to the drawing, the left end of the guide slit 25 has a greater width than the other portions, so that the projection part 141 can slightly move during the play mode and the stop mode.

When the sub-deck 20 is unloaded, the projection part 141 is moved along the guide slit 25 and pivots in association with the unloading of the sub-deck 20, thereby returning to the initial position, as shown in FIG. 5C. In this case, the projection part 141 stops at a right end of the guide slit 25.

As described above, due to the guide slit 25 formed at the sub-deck 20 to operate the pivot lever 140, a dedicated recovery spring as used in conventional devices is not necessary. Accordingly, the number of parts is reduced and the structure is simplified.

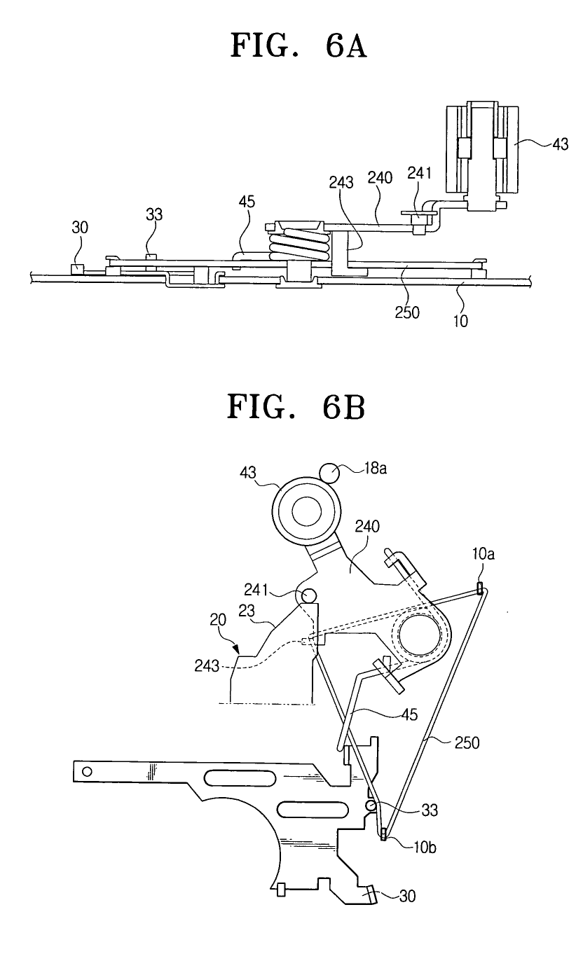

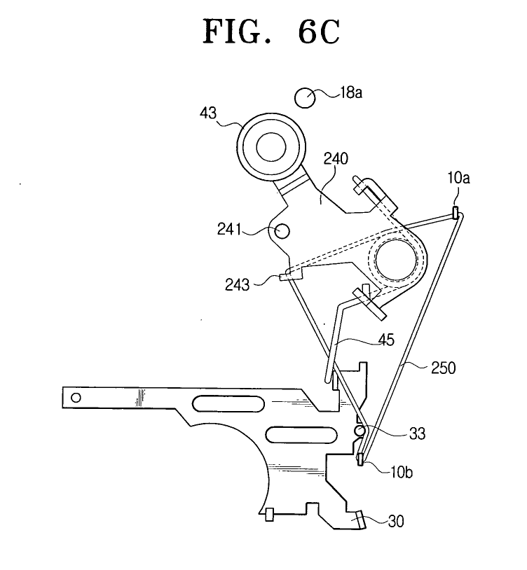

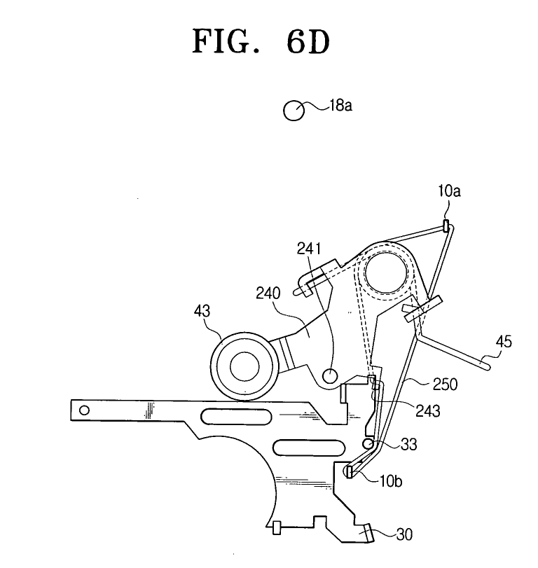

As shown in FIGS. 6A and 6B, an association unit according to still another exemplary embodiment of the present invention comprises a projection part 241 formed on a pivot lever 240, the leading end contact part 23 that extends from the leading end of the sub-deck 20 and pushes the projection part 241 when the sub-deck 20 is loaded, a rubber band 250 connected with and supported by the pivot lever 240 and the main deck 10, and the sliding member 30 mounted on the main deck 10 to slidably move in a direction transverse to the moving direction of the sub-deck 20.

As already described with respect to FIGS. 4A and 4B, the projection part 241 and the leading end contact part 23 move the pivot lever 240 toward the shaft 18a in association with the loading operation of the sub-deck 20.

The rubber band 250 returns the pivot lever 240 to its initial position when the sub-deck 20 is unloaded. A pair of fixing hooks 10a and 10b project from the main deck 10 to catch and support the rubber band 250. The fixing hooks 10a and 10b are disposed on opposite sides of a rotational center of the pivot lever 240 and are preferably integrally formed with the main deck 10.

A holding hook 243 for holding the rubber band 250 is formed on the pivot lever 240 between a rotary shaft of the pivot lever 240 and the pinch roller 43. The holding hook 243 is preferably integrally formed with the pivot lever 240 and extends downward near the main deck 10. When the rubber band 250 is mounted and supported by the fixing hooks 10a and 10b and the holding hook 243, the rubber band 250 forms an approximate triangle.

The rubber band 250 contacts the sliding member 30. Movement of the sliding member 30 increases and decreases the tension of the rubber band 250. To do this, a pressing pin 33 projects from the sliding member 30 and interferes with the rubber band 250.

As shown in FIG. 6B, when the sub-deck 20 is placed in the play mode, the projection part 241 is pushed by the leading end contact part 23 so that the pinch roller 43 contacts the shaft 18a. Also, the torsion spring 45 is pressed by the sliding member 30 to force the pinch roller 43 into tighter contact with the shaft 18a. Here, since the rubber band 250 is in modest tension and does not interfere much with the sliding member 30, the torsion spring 45 is barely influenced by the rubber band 250.

As shown in FIG. 6C, when the sub-deck 20 is in the stop mode, the sliding member 30 is moved a little to the right from the state shown in FIG. 6B. Accordingly, the pressing pin 33 biases the rubber band 250 in one direction. The tension of the rubber band 250 increases, and the pivot lever 240 pivots by the tension of the rubber band 250. Consequently, the pinch roller 43 separates from the shaft 18a.

Referring to FIG. 6D, when the sub-deck 20 is unloaded, the sliding member 30 is moved further to the right. Therefore, the sliding member 30 increases the tension on the rubber band 250. The force of the rubber band 250 pivots the pivot lever 240 to the initial position.

As described above, since the pivot lever 240 can be returned to the initial position using the rubber band 250, the recovery spring used in the conventional pinch roller driving mechanism is not necessary. The rubber band 250 is more cost-effective than the recovery spring. In addition, the rubber band 250 applies less biasing force to the pivot lever 240 than the spring made of metal, thereby exerting less influence on the biasing force pressing the pivot lever 240 into contact with the shaft 18a. As a result, the reliability of the product can be improved.

In the exemplary embodiments where the projection part is magnetized and the guide slit is formed on the sub-deck, since the number of parts is reduced, manufacturing productivity and cost can be improved.

When using an electromagnet, the pivot lever can be adjusted accurately according to the mode of operation, thereby improving the reliability of the product.

Furthermore, when using the rubber band, since the rubber band does not influence the biasing operation of the pivot lever too much, the reliability of the product is enhanced.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A pinch roller driving mechanism for a magnetic recording/reproducing apparatus, comprising:
a main deck mounting a shaft of a capstan motor;
a sub-deck disposed on the main deck, the sub-deck being loaded and unloaded with respect to the main deck;
a pivot lever pivotably mounted to the main deck, the pivot lever supporting a pinch roller that presses a magnetic tape into contact with the shaft of the capstan motor as the sub-deck is loaded; and
an association unit pivoting the pivot lever so that the pinch roller contacts the shaft when the sub-deck is loaded, and returning the pivot lever to its initial position when the sub-deck is unloaded.

2. The pinch roller driving mechanism of claim 1, wherein the association unit comprises:
a projection part that projects from the pivot lever; and
a leading end contact part that extends from a leading end of the sub-deck to contact the projection part and push out the projection part when the sub-deck is loaded,
wherein the projection part is magnetized to maintain contact with the leading end contact part so that when the sub-deck is unloaded, the projection part is attracted towards the leading end contact part by a magnetic force.

3. The pinch roller driving mechanism of claim 2, wherein
the projection part comprises a magnetized pin upwardly projecting from the pivot lever.

4. The pinch roller driving mechanism of claim 1, wherein the association unit comprises:
a projection part that projects from the pivot lever;
a leading end that extends from a leading end of the sub-deck to contact the projection part and push out the projection part when the sub-deck is loaded; and
an electromagnetic part mounted on the sub-deck to face the pivot lever and generate a magnetic force upon application of power, thereby attracting the pivot lever and returning the pivot lever by the magnetic force when the sub-deck is unloaded.

5. The pinch roller driving mechanism of claim 4, wherein the electromagnetic part comprises:
a flexible printed circuit board (FPCB) mounted on the sub-deck and having a pattern for power application; and
an electromagnet connected with the FPCB.

6. The pinch roller driving mechanism of claim 1, wherein the association unit comprises:
a projection part that projects from the pivot lever; and
a guide slit formed at the leading end of the sub-deck to receive the projection part and guide the projection part when the sub-deck is loaded and operate the pivot lever.

7. The pinch roller driving mechanism of claim 6, wherein
the guide slit is formed at a leading end that extends from the leading end of the sub-deck to correspond to the pivot lever.

8. The pinch roller driving mechanism of claim 1, wherein the association unit comprises:
a projection part that projects from the pivot lever;
a leading end contact part that extends from a leading end of the sub-deck to contact the projection part and push out the projection part when the sub-deck is loaded;
a rubber band supported by the pivot lever and the main deck; and
a sliding member mounted to the main deck to move in a sliding manner in a direction transverse to a moving direction of the sub-deck, the movement of the sliding member adjusting the tension applied to the rubber band,
wherein the sliding member moves to increase the tension of the rubber band and return the pivot lever to its initial position.

9. The pinch roller driving mechanism of claim 8, wherein
the main deck comprises at least two fixing hooks for catching and supporting the rubber band, and
the pivot lever comprises a holding hook for holding the rubber band between a shaft of the pivot lever and the pinch roller.

10. The pinch roller driving mechanism of claim 9, wherein
the fixing hooks and the holding hook are arranged to form a triangle.

11. The pinch roller driving mechanism of claim 8, wherein
the sliding member comprises an upwardly projecting pressing pin to contact the rubber band.

12. The pinch roller driving mechanism of claim 11, further comprising
a torsion spring coaxially mounted with the pinch roller, one end of the torsion spring being compressed by interference with the sliding member moving in a direction reducing the tension of the rubber band, thereby biasing the pivot lever toward the shaft.

13. The pinch roller driving mechanism of claim 1, further comprising:
a torsion spring coaxially mounted with the pinch roller; and
a sliding member mounted to the main deck to move in a sliding manner in a direction transverse to the moving direction of the sub-deck,
wherein one end of the torsion spring is compressed by interference with the sliding member as it moves in one direction, thereby biasing the pivot lever toward the shaft.

14. A pinch roller driving mechanism for a magnetic recording/reproducing apparatus, comprising:
a main deck supporting a capstan motor with a shaft;
a sub-deck slidably disposed on the main deck, the sub-deck moving in a loading and unloading direction to load and unload the sub-deck with respect to the main deck;
a pivot lever pivotably disposed on the main deck;
a pinch roller disposed on the pivot lever;
means for engaging the pivot lever so that the pinch roller presses a tape into contact with the shaft of the capstan motor as the sub-deck is loaded; and
magnetic means for returning the pivot lever to its initial position when the sub-deck is unloaded.

15. The pinch roller driving mechanism of claim 14, wherein
the magnetic means includes a magnetic projection part that projects from the pivot lever.

16. The pinch roller driving mechanism of claim 14, wherein
the magnetic means includes an electromagnetic part disposed on the sub-deck, the electromagnetic part generating a magnetic force upon application of power to attract the pivot lever when the sub-deck is unloaded.

17. The pinch roller driving mechanism of claim 14, further comprising:
a sliding member disposed on the main deck, the sliding member moving transversely to the transverse direction to the loading and unloading direction of the sub-deck; and
a torsion spring coaxially mounted with the pinch roller, the sliding member applying a force to one end of the torsion spring to bias the pivot lever toward the shaft.

18. A pinch roller driving mechanism for a magnetic recording/reproducing apparatus, comprising:
a main deck supporting a capstan motor with a shaft;
a sub-deck slidably disposed on the main deck, the sub-deck moving in a loading and unloading direction to load and unload the sub-deck with respect to the main deck;
a pivot lever pivotably disposed on the main deck;
a pinch roller disposed on the pivot lever;
means for engaging the pivot lever so that the pinch roller presses a tape into contact with the shaft of the capstan motor as the sub-deck is loaded;
a rubber band supported by the pivot lever and the main deck; and
a sliding member mounted to the main deck to move transversely to the loading and unloading direction of the sub-deck, the movement of the sliding member adjusting the tension applied to the rubber band,
wherein the sliding member moves to increase the tension of the rubber band to return the pivot lever to its initial position.

19. The pinch roller driving mechanism of claim 8, wherein
the main deck comprises at least two fixing hooks for catching and supporting the rubber band, and
the pivot lever comprises a holding hook for holding the rubber band between a shaft of the pivot lever and the pinch roller.

20. The pinch roller driving mechanism of claim 19, wherein
the fixing hooks and the holding hook are arranged to form a triangle.
